(19) United States
(12) Patent Application Publication
(10) Pub. No.: US 2025/0005887 A1
(43) Pub. Date: Jan. 2, 2025

(54) CLOUD DETECTION FROM MULTISPECTRAL SATELLITE IMAGERY

(71) Applicant: Raytheon Company, Waltham, MA (US)

(72) Inventor: Grant Boroughs, Southlake, TX (US)

(73) Assignee: Raytheon Company, Waltham, MA (US)

(21) Appl. No.: 17/845,431

(22) Filed: Jun. 21, 2022

(51) Int. Cl. G06V 10/34; G06V 10/26; G06V 10/28; G06V 10/58; G06V 20/10; G06V 20/13

(52) U.S. Cl. CPC G06V 10/34; G06V 10/273; G06V 10/28; G06V 10/58; G06V 20/194; G06V 20/13

(57) ABSTRACT

Systems and methods are provided for producing a mask for cloud detection. An exemplary method includes: receiving a multi-band image; collecting a first set of band images and a second set of band images separated by a time lag; forming a first pseudo-pan image and a second pseudo-pan image from the first set of band images and the second set of band images; computing a pixel value difference between each of the corresponding pixels in the first pseudo-pan image and the second pseudo-pan image; extracting from the corresponding pixels a set of candidate cloud pixels; determine whether the candidate cloud pixels have sufficient pixels to define a cloud; in response to determining the candidate cloud pixels have sufficient pixels, performing a morphological clean-up of the candidate cloud pixels to produce a cleaned image of the cloud; and producing, using the cleaned image of the cloud, a cloud mask.

### GOVERNMENT LICENSE RIGHTS

This invention was made with government support under contract number HM047617F0365. The government has certain rights in the invention.

### BACKGROUND

Cloud detection in remote sensing imagery is useful for a variety of image processing applications because clouds can cause false alarms, skew statistics, and slow down processing time. By detecting clouds, they can be masked out of subsequent algorithmic processing so that only unclouded pixels are considered, improving both accuracy and processing speed.

There are many prior art techniques for detecting clouds, but such techniques often provide inaccurate results. For example, prior art techniques include detecting clouds based on objects' spectral signature, size, shape, or texture within an image. This often produces false positives where the images have snow or ice-covered land or other large swaths of land or water that appear white or highly reflective. These approaches also have the shortcoming of often requiring manually adjustment of detection thresholds from image to image as illumination and atmospheric conditions vary.

There is a need for better cloud detection using cloud masks.

### SUMMARY

According to one aspect of the subject matter described in this disclosure, a method of producing a mask for cloud detection is provided. The method includes the following: receiving a multi-band image; collecting, from the multi-band image, a first set of band images and a second set of band images separated by a time lag; forming a first pseudo-pan image and a second pseudo-pan image from the first set of band images and the second set of band images using an intensity balancing, wherein the first pseudo-pan image and the second pseudo-pan image comprise a plurality of corresponding pixels; computing a pixel value difference between each of the plurality of corresponding pixels of the first pseudo-pan image and the second pseudo-pan image; extracting from the plurality of corresponding pixels a set of candidate cloud pixels, the candidate cloud pixels having pixel value differences that surpass a threshold; determining whether the candidate cloud pixels have sufficient pixels to define a cloud; in response to determining the candidate cloud pixels have sufficient pixels, performing a morphological clean-up of the candidate cloud pixels to produce a cleaned image of the cloud; and producing, using the cleaned image of the cloud, a cloud mask.

According to another aspect of the subject matter described in this disclosure, a system for producing a mask for cloud detection is provided. The system includes one or more computing device processors. One or more computing device memories are coupled to the one or more computing device processors. The one or more computing device memories store instructions executed by the one or more computing device processors. The instructions are configured to: receive a multi-band image; collect, from the multi-band image, a first set of band images and a second set of band images separated by a time lag; form a first pseudo-pan image and a second pseudo-pan image from the first set of band images and the second set of band images using an intensity balancing, wherein the first pseudo-pan image and the second pseudo-pan image comprise a plurality of corresponding pixels; compute a pixel value difference between each of the plurality of corresponding pixels of the first pseudo-pan image and the second pseudo-pan image; extract from the plurality of corresponding pixels a set of candidate cloud pixels, the candidate cloud pixels having pixel value differences that surpass a threshold; determine whether the candidate cloud pixels have sufficient pixels to define a cloud; in response to determining the candidate cloud pixels have sufficient pixels, performing a morphological clean-up of the candidate cloud pixels to produce a cleaned image of the cloud; and producing, using the cleaned image of the cloud, a cloud mask.

According to another aspect of the subject matter described in this disclosure, a non-transitory computer-readable storage medium is provided. The non-transitory computer-readable storage medium stores instructions which when executed by a computer causing the computer to perform a method for producing a mask for cloud detection, the method comprising: receiving a multi-band image; collecting, from the multi-band image, a first set of band images and a second set of band images separated by a time lag; forming a first pseudo-pan image and a second pseudo-pan image from the first set of band images and the second set of band images using an intensity balancing, wherein the first pseudo-pan image and the second pseudo-pan image comprise a plurality of corresponding pixels; computing a pixel value difference between each of the plurality of corresponding pixels of the first pseudo-pan image and the second pseudo-pan image; extracting from the plurality of corresponding pixels a set of candidate cloud pixels, the candidate cloud pixels having pixel value differences that surpass a threshold; determining whether the candidate cloud pixels have sufficient pixels to define a cloud; in response to determining the candidate cloud pixels have sufficient pixels, performing a morphological clean-up of the candidate cloud pixels to produce a cleaned image of the cloud; and producing, using the cleaned image of the cloud, a cloud mask.

Additional features and advantages of the present disclosure is described in, and will be apparent from, the detailed description.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 is a schematic diagram of a computer-implemented system for processing a multi-band image, in accordance with some embodiments.

FIG. 2 is a flowgraph of operations included in an example method for producing a mask for cloud detection, in accordance with some embodiments.

FIGS. 3A-3C are schematic diagrams illustrating the benefits of using a cloud mask formed using the method of FIG. 2, in accordance with some embodiments.

FIG. 4 is a schematic diagram of components that may be included in the computing system shown in FIG. 1, in accordance with some embodiments.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”. “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features. integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

The present disclosure provides a fully automated computer-implemented system and method for detecting clouds This approach is applied to multi-band images with a sufficient time delay between band collection. An intensity balancing approach is used to combine the bands from each collection group into a single-band weighted average image known as a pseudo-pan image. In this case, two pseudo-pan images are produced. Due to the intensity balancing, ground pixels have similar values between the two band sets. Cloud pixels exhibit larger differences between the two band sets due to their motion. Differences that are above a certain threshold are candidate clouds.

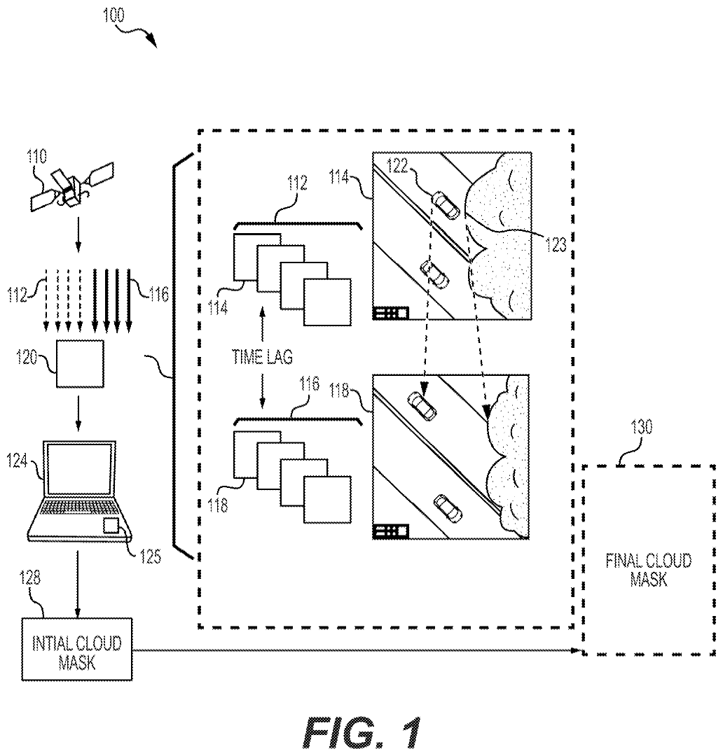

FIG. 1 is a schematic diagram of a computer-implemented system 100 for processing a multi-band image, in accordance with some embodiments. A Multi-Spectral Imaging (MSI) satellite 110 collects a first set 112 of band images 114 (Near-IR2, Coastal Blue, Yellow and Red-Edge) and a second set 116 of band images 118 (Blue, Green, Red and Near-IR.1) separated by a time lag that define a multi-band image 120. As shown, objects 122 and 123 have changed position against an otherwise static background from a band image 114 in the first set to a band image 118 in the second set due to the collection time lag. Note object 123 is a moving cloud. A computing system 124 includes a non-transitory medium 125 (e.g. memory) that is programmed to process a single multi-band image 120 to compute an initial cloud mask 128 that is cleaned-up to produce a final cloud mask 130.

The computer-implemented system 100 is configured exploit the time lag between the sets of band images to detect clouds and generate an output including at least the location of each detected cloud.

In some embodiments, WorldView (WV) images, WV-2 or WV-3, having 8-band images are used. In this case, the first set of band images may include Near-IR2 (860-1040 nm), Coastal Blue (400-450 nm), Yellow (585-625 nm) and Red-Edge (705-745 nm) images and the second set of band images may include Blue (450-510 nm), Green (520-580 nm, Red (630-690 nm) and Near-IRI (770-895 nm) images. There is a time lag of 0.2-0.3 seconds between the first and second sets of band images. Other multi-band images may be used having other suitable time lags between at least two bands. In some embodiments, the system 100 generates resampled band images that sub-pixel column misregistration to improve image quality for subsequent processing.

The computer-implemented system 100 are configured to apply morphological analysis and clean-up to output the final cloud mask 130.

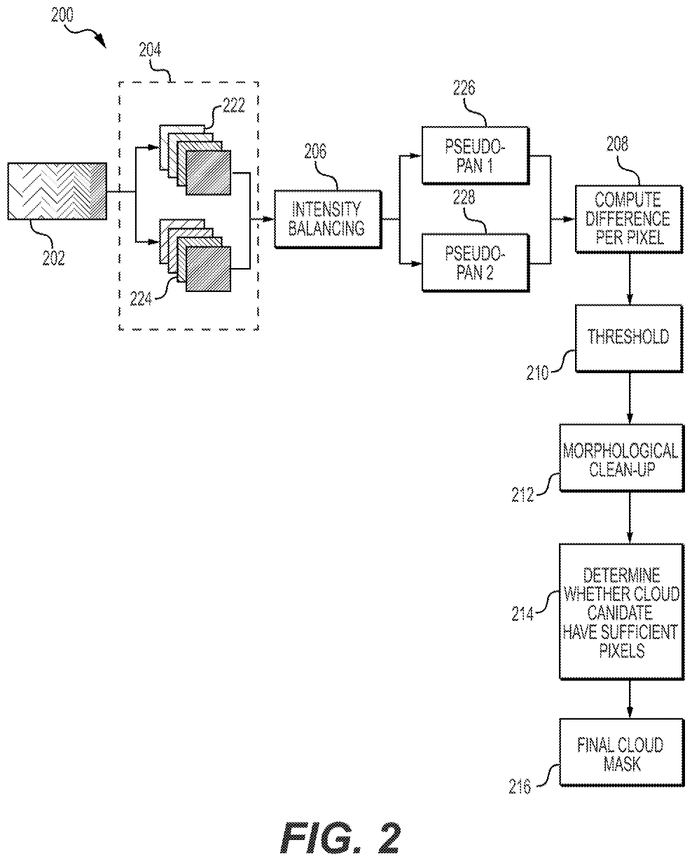

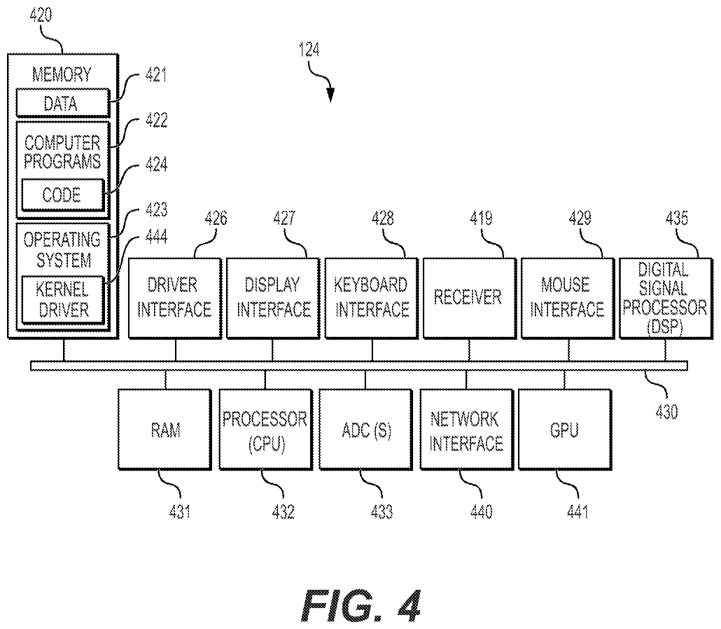

FIG. 2 is a flowgraph of operations included in an example method 200 for producing a mask for cloud detection, in accordance with some embodiments. The operations may be implemented using computer-executable instructions stored on one or more non-transitory machine-readable storage media. The instructions may be executed by one or more processing devices, such as the processor(s) used in computing system 124, as described in FIG. 1 and FIG. 4, to implement the operations.

Method 200 includes receiving a multi-band image (such as multi-band image 120) from a multispectral satellite (step 202). Method 200 includes collecting a first set 222 (such as first set 112) of band images (such as band images 114) and a second set 224 (such as second set 116) of band images (such as band images 118) separated by a time lag defined by the multi-band image (Step 204). To condition the band images, method 200 includes forming first pseudo-pan image 226 and second pseudo-pan image 228 from the first set of band images 222 and the second set of band images 224 using an intensity balancing, such as least squares intensity balancing (Step 206). As an example, the intensity balancing may be a least-squares intensity balancing that combines the 4 bands from each set of band images 222 and 224 into a single-band weighted average image known as a pseudo-pan image. This yields two pseudo-pan images 226 and 228 with similar intensity profiles and a slight time separation.

Because each band has its own spectral response, the same feature can have different intensities in different bands, so in order to make the cloud detection processing more accurate, it is helpful to balance the intensities of the pseudo-pan images 226 and 228. The least-squares intensity matching approach involves the first image pseudo-pan image 226 being a simple average of its bands and the second pseudo-pan image 228 using a least-squares approach to solve for a gain gᵢ for each band and a total offset c that best matches the pixel values of first pseudo-pan image 226.

$${g}_{1} {b}_{1} + {g}_{2} {b}_{2} + … + {g}_{n} {b}_{n} + c = p \qquad ( Eq . 1 )$$

To balance first pseudo-pan image 226 and second pseudo-pan image 228, an observation matrix is constructed using the band values for each pixel of second set 224 of the band images. If there are k pixels, the observation matrix for n bands is:

$$A = [ \begin{matrix}{b}_{1}^{1} & … & {b}_{n}^{1} & 1 \\ ⋮ & ⋱ & ⋮ & 1 \\ {b}_{1}^{k} & … & {b}_{n}^{k} & 1\end{matrix} ] \qquad ( Eq . 2 )$$

where the column of 1's is for the constant offset c. And the pseudo-pan values matrix for first pseudo-pan image 224 is:

$$B = [ \begin{matrix}{p}^{1} \\ ⋮ \\ {p}^{k}\end{matrix} ] \qquad ( Eq . 3 )$$

The least-squares solution for the gains and offset is then obtained by:

$${( {A}^{T} A )}^{- 1} ( {A}^{T} B ) \qquad ( Eq . 4 )$$

The resulting array is the gain values and the offset value. The gains and offset are applied to the pixel values of second set 224 of the band images to yield second pseudo-pan image 228 as described in (Eq. 1). Alternately, a single gain and offset may be calculated but provides less accurate balancing. Note for the least-squares approach to work first pseudo-pan image 226 and second pseudo-pan image 228 each have the same number of corresponding pixels.

In other embodiments, other intensity balancing techniques may be used in place of the least-squares intensity balancing.

Method 200 includes computing a pixel value difference between each of the corresponding pixels of pseudo-pan images 226 and 228 (Step 208). In this case, the pixel value difference between the first pixel of first pseudo-pan image 226 and the first pixel value of second pseudo-pan image 228 is computed. This is repeated to compute the pixel value difference for the remaining corresponding pixels in first pseudo-pan image 226 and second pseudo-pan image 228. Because of the intensity balancing, ground pixels may have similar values between the two pseudo-images 226 and 228. Cloud pixels exhibit larger differences per pixel between the two pseudo-images 226 and 228 due to their motion and reflectivity. The apparent cloud motion in the imagery may be due to actual atmospheric motion and/or the relative displacement of the sensor position during the time lag between band collections; both sources of apparent cloud motion are useful for this process. A threshold analysis is done by extracting from the corresponding pixels in pseudo-pan images 226 and 228 candidate cloud pixels with pixel value differences that surpass a threshold (Step 210). A determination is made whether the candidate cloud pixels have sufficient pixels to define a cloud (Step 212). Pixel value differences that may be above a certain absolute threshold and/or above a certain relative (percentage) threshold are candidate clouds. In some embodiments, spatial processing may be used to group candidate cloud pixels into contiguous clusters, and clusters that are large enough are considered clouds.

In response to determining there are sufficient pixels, method 200 includes performing a morphological clean-up of the candidate cloud pixels to produce an image of the cloud (Step 214). The morphological clean-up removes noise and other unneeded features to produce a cloud image. A cloud mask, such as final cloud mask 130, is produced using the cloud image (Step 216). Optionally, the cloud mask may be registered back with a co-collected multispectral imagery system for processing.

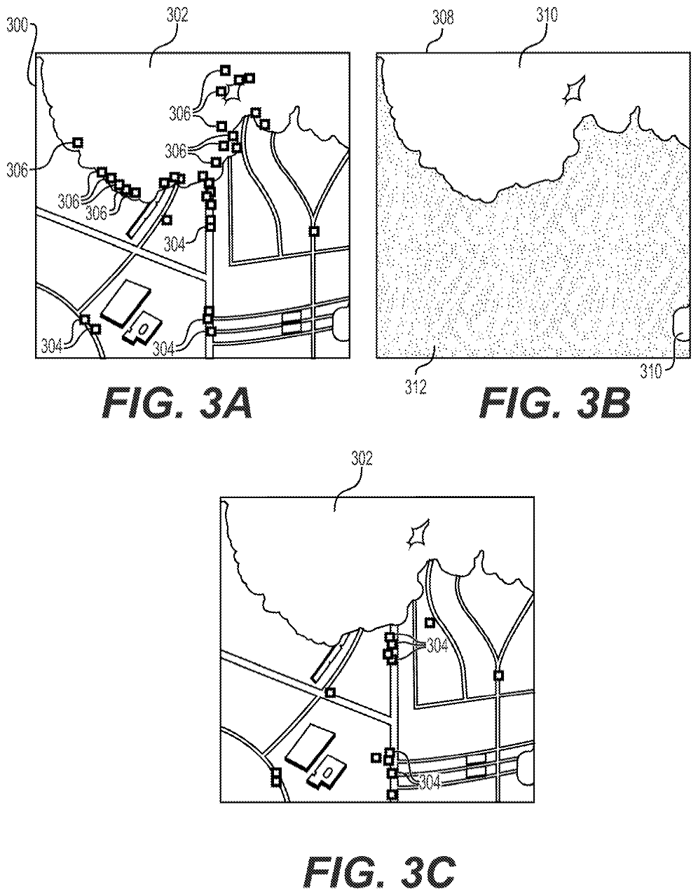

FIGS. 3A-3C are schematic diagrams illustrating the benefits of using a cloud mask formed using method 200 of FIG. 2. One of the benefits of using the cloud detection technique described herein is in motion detection applications. FIG. 3A is an example MSI 300 of a particular city with city markings 304 indicating motion detection of vehicles. Image 300 includes a cloud 302 above the city. In this case, cloud markings 306 in proximity to cloud 302 indicate numerous false alarms caused by the motion of cloud 302. Typically, clouds can cause false alarms, skew statistics, and slow down processing time in many image applications.

An accurate cloud mask, like the one described herein, may aid in lowering false alarms, improving statistics, and improving processing time. The clouds may be masked out in subsequent algorithmic processing so that only unclouded pixels are considered, improving accuracy and processing speed. FIG. 3B is a cloud mask 308 formed using method 200 described herein. Cloud mask 308 includes regions 310, defined by cloud 302. and region 312, determined by regions not covered by cloud 302 and indicative of ground features. FIG. 3C shows an improvement in lowering the number of false flags around cloud 302 after applying cloud mask 308 compared to FIG. 3A. In this implementation, cloud mask 308 masked out clouded pixels eliminating false alarms due to the motion of cloud 302 while leaving unclouded pixels for motion detection analysis.

FIG. 4 is a schematic diagram of components that may be included in computing system 124 of FIG. 1, in accordance with some embodiments. As shown in FIG. 4, computing system 124 includes memory 420, which may include a non-transitory computer-readable medium such as a computer hard disk. Memory 420 stores data 421, computer programs 422, and operating system 423, among other things. The operating system 423 includes a driver, for example a kernel driver 444, for controlling the operations of computer system 124. Among the computer programs stored in memory 420 is computer code 424 associated with method 200. Also included in computing system 124 are drive interface 426, display interface 427, keyboard interface 428, mouse interface 429, one or more computer buses 430, random access memory (RAM) 431, processor (CPU) 1332, and graphic processing unit (GPU) 1341. The computer system 124 may include a display that works in conjunction with display interface 427, and a keyboard that works in conjunction with keyboard interface 428 for inputting text and user commands. Also, the computer system 124 may include a mouse that works in conjunction with mouse interface 429 for positioning a cursor on display screen and for inputting user commands.

In some embodiments, memory 420 may contain multiple memory components for storing data. In some embodiments, RAM 431 may contain multiple RAMs for processing computer instructions.

Processor 432 may be a microprocessor, programmable logic, or the like for executing computer programs, such those noted above, out of RAM 431. Processor 432 accesses computer programs (or other data) stored on an external device via drive interface 426. GPU 441 is a type of processing device. For example, the GPU 441 may be a programmable logic chip that is configured to implement and to control display functionality. To this end, a GPU 441 may be programmed to render images, animation, and video on the computer's screen. The GPU 441 may be located on a plug-in card or in a chipset on the motherboard of the computing system, or the GPU 441 may be in the same physical chip as the CPU 432. In some implementations, the CPU 432 may contain multiple CPUs. The multiple CPUs may be configured for parallel computing, in some embodiments.

The computer system 124 may have a receiver 419, e.g., a radio receiver, to receive and/or transmit information wirelessly or the like. Computing system 124 may also include one or more analog to digital converters (ADC) 433 to convert incoming analog RF signals from receiver 419 to digital samples. The computing system 124 may also include a digital signal processor (DSP) 435 to perform digital signal processing operations on the digital samples. The DSP 435 may also be operated to improve the quality of the digital samples. The DSP may also be capable of executing computer programs that do not relate to signal processing.

Computing system 124 includes a network interface 440, such as an Ethernet port, for interfacing to a network, such as the Internet. In some embodiments, computing system 124 may be a server connected to multiple computing systems 124.

In some implementations, multiple electronic components, such as the GPU 441, the CPU 432, and/or the DSP 435, may execute one or more computer programs concurrently or contemporaneously. In some implementations, the GPU 441 may contain multiple components of each type shown in FIG. 4; for example, multiple CPUs, multiple GPUs. multiple DSPs, and so forth. One or more of each type of component may be configured to execute one or more computer programs concurrently, contemporaneously, or simultaneously.

The disclosure describes a system and method for cloud detection. The advantages provided by the system and method for cloud detection include not requiring spectral band math and associated thresholding. The observation that clouds have distinctive intensity differences between time-lag band collections leads to a highly accurate approach for masking. Also, the system and method for cloud detection are configured to use least-squares intensity balancing and pseudo-pan image formation for the best estimation of effective intensity differences. One application of the system and method for cloud detection is lowering false alarms in motion detection applications caused by cloud motion using the cloud mask described herein.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance.” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof.

Accordingly, the present disclosure is intended to be illustrative, but not limiting, of the scope of the present disclosure, which is set forth in the following claims.

What is claimed is:

1. A system for producing a mask for cloud detection, the system comprising
one or more computing device processors; and
one or more computing device memories, coupled to the one or more computing device processors, the one or more computing device memories storing instructions executed by the one or more computing device processors, wherein the instructions are configured to:
receive a multi-band image;
collect, from the multi-band image, a first set of band images and a second set of band images separated by a time lag;
form a first pseudo-pan image and a second pseudo-pan image from the first set of band images and the second set of band images using an intensity balancing, wherein the first pseudo-pan image and the second pseudo-pan image comprise a plurality of corresponding pixels;
compute a pixel value difference between each of the plurality of corresponding pixels of the first pseudo-pan image and the second pseudo-pan image;
extract from the plurality of corresponding pixels a set of candidate cloud pixels, the candidate cloud pixels having pixel value differences that surpass a threshold;
determine whether the candidate cloud pixels have sufficient pixels to define a cloud;
in response to determining the candidate cloud pixels have sufficient pixels, performing a morphological clean-up of the candidate cloud pixels to produce a cleaned image of the cloud; and
producing, using the cleaned image of the cloud, a cloud mask.

2. The system of claim 1, wherein the first set of band images and the second set of band images comprise different spectral ranges relative to each other.

3. The system of claim 1, wherein while receiving the multi-band image, the instructions are configured to receive the multi-band image from a multispectral imaging system.

4. The system of claim 1, wherein while forming the first pseudo-pan image and the second pseudo-pan image, the instructions are configured to average the first set of band images to derive the first-pseudo-pan image.

5. The system of claim 1, wherein while forming the first pseudo-pan image and the second pseudo-pan image, the instructions are configured to perform a least-squares approach on the second set of band images using pixel values of the first-pseudo-pan image to derive the second pseudo-pan image.

6. The system of claim 1, wherein the candidate cloud pixels comprise larger differences per pixel between the first pseudo-pan image and the second pseudo-pan image.

7. The system of claim 1, wherein the threshold comprises an absolute threshold and/or a relative threshold.

8. The system of claim 1, wherein the cloud mask comprises a first region defining a cloud and a second region defining ground features.

9. The system of claim 1, wherein the morphological clean-up comprises removal of noise and other unneeded features to produce the cloud image.

10. A method for producing a mask for cloud detection, the method comprising:
receiving a multi-band image;
collecting, from the multi-band image, a first set of band images and a second set of band images separated by a time lag;
forming a first pseudo-pan image and a second pseudo-pan image from the first set of band images and the second set of band images using an intensity balancing, wherein the first pseudo-pan image and the second pseudo-pan image comprise a plurality of corresponding pixels;
computing a pixel value difference between each of the plurality of corresponding pixels of the first pseudo-pan image and the second pseudo-pan image;
extracting from the plurality of corresponding pixels a set of candidate cloud pixels, the candidate cloud pixels having pixel value differences that surpass a threshold;
determining whether the candidate cloud pixels have sufficient pixels to define a cloud;
in response to determining the candidate cloud pixels have sufficient pixels, performing a morphological clean-up of the candidate cloud pixels to produce a cleaned image of the cloud; and
producing, using the cleaned image of the cloud, a cloud mask.

11. The method of claim 10, wherein the first set of band images and the second set of band images comprise different spectral ranges relative to each other.

12. The method of claim 10, wherein receiving the multi-band image comprises receiving the multi-band image from a multispectral imaging system.

13. The method of claim 10, wherein forming the first pseudo-pan image and the second pseudo-pan image comprises averaging the first set of band images to derive the first-pseudo-pan image.

14. The method of claim 10, wherein forming the first pseudo-pan image and the second pseudo-pan image comprises performing a least-squares approach on the second set of band images using pixel values of the first-pseudo-pan image to derive the second pseudo-pan image.

15. The method of claim 10, wherein the candidate cloud pixels comprise larger differences per pixel between the first pseudo-pan image and the second pseudo-pan image.

16. The method of claim 10, wherein the threshold comprises an absolute threshold and/or a relative threshold.

17. The method of claim 10, wherein the cloud mask comprises a first region defining a cloud and a second region defining ground features.

18. The method of claim 10, wherein the morphological clean-up comprises removal of noise and other unneeded features to produce the cloud image.

19. The method of claim 10 further comprising registering the cloud mask with a co-collected multispectral imagery system for processing.

20. A non-transitory computer-readable storage medium storing instructions which when executed by a computer cause the computer to perform a method for producing a mask for cloud detection, the method comprising:
receiving a multi-band image;
collecting, from the multi-band image, a first set of band images and a second set of band images separated by a time lag;
forming a first pseudo-pan image and a second pseudo-pan image from the first set of band images and the second set of band images using an intensity balancing, wherein the first pseudo-pan image and the second pseudo-pan image comprise a plurality of corresponding pixels;
computing a pixel value difference between each of the plurality of corresponding pixels of the first pseudo-pan image and the second pseudo-pan image;
extracting from the plurality of corresponding pixels a set of candidate cloud pixels, the candidate cloud pixels having pixel value differences that surpass a threshold
determining whether the candidate cloud pixels have sufficient pixels to define a cloud;
in response to determining the candidate cloud pixels have sufficient pixels, performing a morphological clean-up of the candidate cloud pixels to produce a cleaned image of the cloud; and
producing, using the cleaned image of the cloud, a cloud mask.
